(19) United States
(12) Patent Application Publication
(10) Pub. No.: US 2018/0141037 A1
(43) Pub. Date: May 24, 2018

(54) ION EXCHANGE COLUMN AND METHODS OF MAKING AND USING THE SAME

(71) Applicants: Dayanand SAINI, Bakersfield, CA (US); Usama SULTAN, Bakersfield, CA (US); Mina A. GHEBRYAL, Bakersfield, CA (US)

(72) Inventors: Dayanand SAINI, Bakersfield, CA (US); Usama SULTAN, Bakersfield, CA (US); Mina A. GHEBRYAL, Bakersfield, CA (US)

(73) Assignee: CSUB Auxiliary for Sponsored Programs Administration, Bakersfield, CA (US)

(21) Appl. No.: 15/679,479

(22) Filed: Aug. 17, 2017

Related U.S. Application Data
(60) Provisional application No. 62/425,389, filed on Nov. 22, 2016.

(51) Int. Cl. B01J 47/026; B01D 15/36; C02F 1/42; B01J 39/18

(52) U.S. Cl. CPC B01J 47/026; B01D 15/361; C02F 2001/425; B01J 39/18; C02F 1/42

(57) ABSTRACT

An ion exchange column and a method of using the same are disclosed. The ion exchange column includes first interconnected chambers supporting a first portion of an ion exchange resin, second interconnected chambers supporting a second portion of the ion exchange resin, and a housing or casing enclosing the first and second interconnected chambers and the first and second ion exchange resin portions. The second chambers are physically isolated and/or separated from the first chambers. The ion exchange column is configured to cause a fluid passing through the first or second interconnected chambers to travel along a path that is longer than a height of the interconnected chambers. The present column and method improve efficiencies of fluid treatment and resin regeneration relative to a conventional dual-column design, and increase residence time between the resin and the fluid or regenerant relative to an otherwise identical single-column design.

### RELATED APPLICATION(S)

This application claims priority to U.S. Provisional Pat. Appl. No. 62/425,389, filed Nov. 22, 2016, which is incorporated herein by reference in its entirety.

### FIELD OF THE INVENTION

The present invention generally relates to the fields of ion exchange and water purification. More specifically, embodiments of the present invention pertain to an ion exchange column and methods of making and using the same.

### DISCUSSION OF THE BACKGROUND

In most currently available commercial ion exchange processes, once the resin loses its ion exchange efficiency to remove the targeted ion (e.g. Ca⁺², Mg⁺², B⁺³) from the feed water, an interruption in the feed water treatment process occurs when the spent resin loses it effect (i.e., when it is no longer effective and needs to be regenerated). In currently available commercial ion exchange processes, either the treatment of the feed water is stopped to regenerate the spent resin, or the feed water stream is switched over to a stand-by ion exchange column containing fresh resin. Both of these arrangements are inefficient and relatively costly.

U.S. Pat. No. 6,972,091 (to Becucci) discloses a multi-compartment tank in which one compartment effects water demineralization, while the other compartment simultaneously regenerates the ion exchanging resin. Becucci teaches that the demineralization step and the regeneration step start contemporaneously, but the regeneration step ends sooner than the demineralization step. After the regeneration step ends, the regeneration compartment remains in “standby” mode while the demineralization step finishes. Also, Becucci teaches that the demineralization compartment may be located either directly over or directly under the regeneration compartment in the same tank.

This “Discussion of the Background” section is provided for background information only. The statements in this “Discussion of the Background” are not an admission that the subject matter disclosed in this “Discussion of the Background” section constitutes prior art to the present disclosure, and no part of this “Discussion of the Background” section may be used as an admission that any part of this application, including this “Discussion of the Background” section, constitutes prior art to the present disclosure.

### SUMMARY OF THE INVENTION

One purpose of the present invention is to eliminate any need for a stand-by ion exchange column and to reduce or eliminate the down-time to regenerate spent resin in any (dual column or a single column) ion exchange process in general, and more specifically, in water hardness treatment and boron removal ion exchange processes. Thus, the present invention relates in part to an ion exchange bed or column, comprising a first plurality of interconnected chambers supporting a first portion of an ion exchange resin, a second plurality of interconnected chambers supporting a second portion of the ion exchange resin, and a housing or casing enclosing the first and second plurality of interconnected chambers and the first and second portions of the ion exchange resin. The second plurality of interconnected chambers is physically isolated and/or separated from the first plurality of interconnected chambers. The ion exchange bed or column is configured to cause a fluid passing through the first plurality of interconnected chambers to travel along a path that is longer than a height of the first plurality of interconnected chambers, and the fluid passing through the second plurality of interconnected chambers to travel along a path that is longer than a height of the second plurality of interconnected chambers.

In one embodiment, the first plurality of interconnected chambers comprises a first chamber, a second chamber, and a conduit connecting the first chamber to the second chamber. In another or a further embodiment, the second plurality of interconnected chambers comprises a third chamber, a fourth chamber, and one or more openings connecting the third chamber to the fourth chamber. The ion exchange bed or column may further comprise a first partition separating the first chamber from the fourth chamber, a second partition separating the first chamber from the third chamber, a third partition separating the second chamber from the fourth chamber, and a fourth partition separating the second chamber from the third chamber.

Embodiments of the present invention also relate to a method of exchanging ions in a fluid, comprising passing the fluid through (i) a first portion of an ion exchange resin in a first plurality of interconnected chambers and (ii) a second portion of the ion exchange resin in a second plurality of interconnected chambers. As in the ion exchange column or bed, the second plurality of interconnected chambers is physically isolated and/or separated from the first plurality of interconnected chambers, and the ion exchange bed or column is configured to cause the fluid passing through the first plurality of interconnected chambers to travel along a path that is longer than a height of the first plurality of interconnected chambers, and the fluid passing through the second plurality of interconnected chambers to travel along a path that is longer than a height of the second plurality of interconnected chambers. The fluid is passed through the first and second portions of the ion exchange resin in the first and second pluralities of interconnected chambers for a first period of time. After the first period of time, the method regenerates the first portion of the ion exchange resin in the first plurality of interconnected chambers while continuing to pass the fluid through the second portion of the ion exchange resin in the second plurality of interconnected chambers. After the first portion of the ion exchange resin is regenerated, the method regenerates the second portion of the ion exchange resin in the second plurality of interconnected chambers while passing the fluid through the first portion of the ion exchange resin in the first plurality of interconnected chambers.

In general, the fluid comprises water, and advantageously, the method is continuously repeated. The method may further comprise, prior to the first period of time, passing the fluid through the first portion of the ion exchange resin in the first plurality of interconnected chambers for an initial period of time. In another or a further embodiment, regenerating each of the first and second portions of the ion exchange resin comprises passing a regenerant through the corresponding or respective portion of the ion exchange resin.

In one embodiment, each of the first and second portions of the ion exchange resin has a unit volume of S, the fluid is passed through each of the first and second pluralities of interconnected chambers at a flow rate of n*S unit volumes/hr, the ion exchange resin in each of the first and second pluralities of interconnected chambers is regenerated after passing m*S unit volumes of fluid through the corresponding or respective plurality of interconnected chambers, each of the first and second portions of the ion exchange resin is regenerated with x*S unit volumes of regenerant, and the regenerant is passed through the corresponding or respective first and second portions of the ion exchange resin at a flow rate of y*S unit volumes/hr. When (m/n>2(x/y), the method may further comprise passing the fluid through the first and second portions of the ion exchange resin in the first and second pluralities of interconnected chambers for a second period of time, after regenerating the first portion of the ion exchange resin and prior to regenerating the second portion of the ion exchange resin.

The economic potential and commercial applications for the present invention are significant, as it not only cuts the capital cost (e.g., any need for two ion exchange columns), but it also reduces operating costs by allowing concurrent regeneration of spent resin in same ion exchange column (e.g., by reducing the down time for regenerating the spent resign in a single-column ion exchange process). These and other advantages of the present invention will become readily apparent from the detailed description of various embodiments below.

### BRIEF DESCRIPTION OF THE DRAWINGS

FIG. 1A shows a cross-section of an exemplary ion exchange column or bed in accordance with one or more embodiments of the present invention, FIG. 1B is a top-down view of the exemplary ion exchange column or bed of FIG. 1A across the mid-section of the exemplary ion exchange column or bed, and FIG. 1C is an exploded perspective view of the partitions and interconnections between the chambers of the exemplary ion exchange column or bed.

FIG. 2 shows a tortuous flow of a treated fluid through the exemplary ion exchange column or bed of FIG. 1A.

FIG. 3 shows a tortuous flow of a regenerant through the exemplary ion exchange column or bed of FIG. 1A.

### DETAILED DESCRIPTION

Reference will now be made in detail to various embodiments of the invention, examples of which are illustrated in the accompanying drawings. While the invention will be described in conjunction with the following embodiments, it will be understood that the descriptions are not intended to limit the invention to these embodiments. On the contrary, the invention is intended to cover alternatives, modifications and equivalents that may be included within the spirit and scope of the invention as defined by the appended claims. Furthermore, in the following detailed description, numerous specific details are set forth in order to provide a thorough understanding of the present invention. However, it will be readily apparent to one skilled in the art that the present invention may be practiced without these specific details. In other instances, well-known methods, procedures, components, and circuits have not been described in detail so as not to unnecessarily obscure aspects of the present invention.

The technical proposal(s) of embodiments of the present invention will be fully and clearly described in conjunction with the drawings in the following embodiments. It will be understood that the descriptions are not intended to limit the invention to these embodiments. Based on the described embodiments of the present invention, other embodiments can be obtained by one skilled in the art without creative contribution and are in the scope of legal protection given to the present invention.

Furthermore, all characteristics, measures or processes disclosed in this document, except characteristics and/or processes that are mutually exclusive, can be combined in any manner and in any combination possible. Any characteristic disclosed in the present specification, claims, Abstract and Figures can be replaced by other equivalent characteristics or characteristics with similar objectives, purposes and/or functions, unless specified otherwise.

For the sake of convenience and simplicity, the terms “connected to,” “coupled with,” “coupled to,” and “in communication with” are generally used interchangeably herein, but are generally given their art-recognized meanings. The term “algorithm” as used in this application may refer to a set of steps that are followed in order to solve a mathematical problem or to complete a particular process (which may be automated). The term “equation” as used in this application may refer to a formal or substantially formal statement of the equivalence of a mathematical or logical expression.

The invention, in its various aspects, will be explained in greater detail below with regard to exemplary embodiments.

An Exemplary Ion Exchange Column and Process

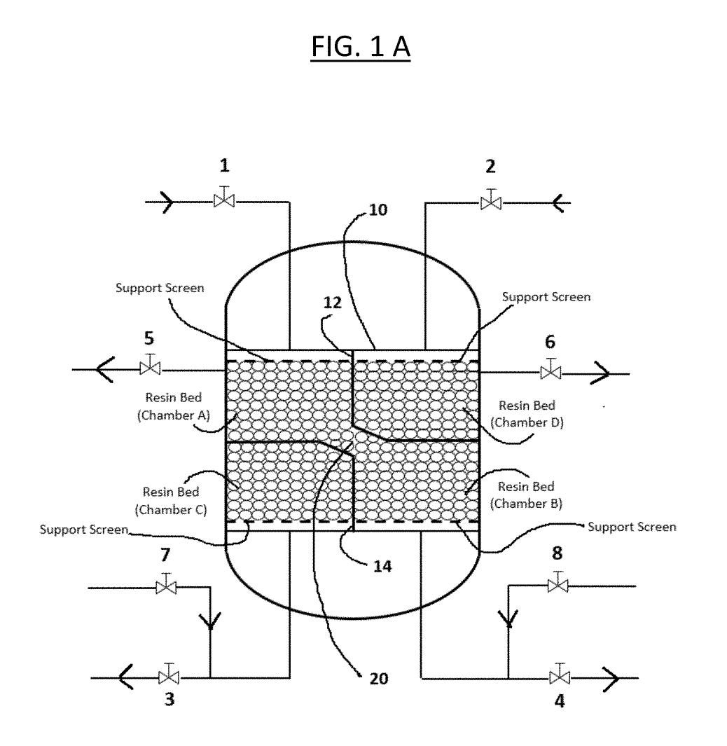

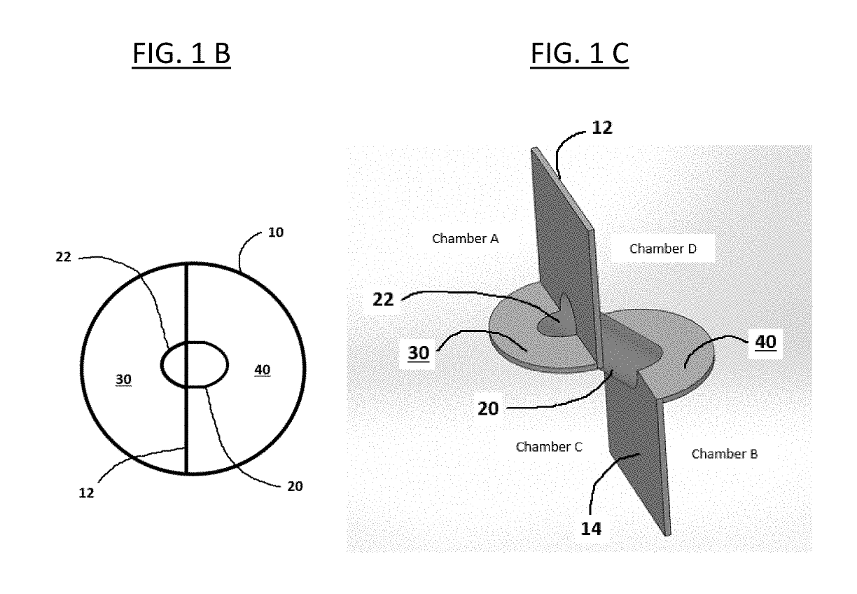

The present invention is based on the unique design and/or compartmentalization of an ion exchange column 10 (FIG. 1A). It facilitates the concurrent regeneration of spent resin without an interruption in the feed water treatment, thus eliminating the downtime needed for regeneration of spent resin and need of a standby column. The unique compartmentalization design consists of at least four compartments interconnected in pairs (e.g., A+B and C+D in FIG. 1A). Initially, the pairs of interconnected compartments are loaded with the resin. A first pair is used to treat the water (e.g., remove the targeted ion from the feed water). When the resin is spent (e.g., when it loses its efficiency and is no longer effective) in the first pair of compartments, feed water flow is turned to a second pair of compartments while the regeneration process (e.g., flow of regenerant) is initiated for recovering the spent resin from the first pair of compartments. This allows the concurrent regeneration of spent resin without interrupting the treatment of feed water, and without a significant loss of the treatment capacity (e.g., the number of bed volumes) of the ion exchange column.

Advantages of the present invention (e.g., concurrent regeneration of spent resin in a continuous or substantially continuous ion exchange process) over existing ion exchange-based water treatment processes include eliminating the need for a stand-by column (e.g., a dual-column ion exchange processes), and facilitating the regeneration of spent resin while allowing continuous feed water treatment in the same column (e.g., a single column-based ion exchange process). It also makes the overall process less costly.

The present invention is not limited to any specific ion-exchange resin. However, in some embodiments, any commercially-available strong acid cation (SAC), mixed-bed resin (e.g., a mixture of strong acid cation [SAC] and strong base anion [SBA] exchangers), or boron-specific ion exchange resins may be used.

The principle(s) of the present invention may be explained with reference to the drawings and the following example calculations. Assume, for example, that the total bed volume of the ion exchange column or bed 10 in FIG. 1A is 2S. Each of the chambers (A, B, C and D) has approximately an equal amount of resin (e.g., bed volume). Hence, each chamber has a bed volume equivalent to S/2 (e.g., S/2 or about S/2).

Chambers A and B are interconnected by a pipe, neck or other conduit 20. The total bed volume of the interconnected chambers A+B is S or about S.

FIG. 1B is a top-down, cross-sectional view of the ion exchange column or bed 10 of FIG. 1A. An upper partition 12 separates chambers A and D (FIG. 1A). Referring back to FIG. 1B, the conduit 20 has an opening 22 in part in the partition 30 between chambers A and C, and in part along the bottommost part of the upper partition 12, although the design is not limited thereto. For example, the opening 22 may be entirely in in the partition 30. The conduit 20 connects chamber A to an opening (not shown) in the partition 40 between chambers D and B to allow fluid to flow between chambers A and B. The opening in the partition 40 may also extend to an uppermost portion of a lower partition 14 (FIG. 1A) between chambers B and C.

Similarly, chambers C and D are interconnected. FIG. 1C is an exploded perspective view of the conduit 20 and the partitions 12, 14, 30 and 40. There is a gap or space between the lowermost surface of partition 30 and the uppermost surface of partition 40. Typically, however, upper and lower partitions 12 and 14 are aligned, as shown in FIG. 1A. This allows fluid to flow between chambers C and D. The total bed volume of the interconnected chambers C+D is S or about S.

All chambers A, B, C and D of the ion exchange column 10 are generally filled with the same resin. Assume, for example, that the resin in each of the interconnected chamber pairs (e.g., A+B and C+D) is totally spent after treating/softening m*S bed volumes of water (e.g., a total of 2m*S bed volumes of water for the entire column 10), and the feed water flow rate is n*S bed volumes/hr/interconnected chamber pair. The total water treatment/softening flow rate is 2n*S bed volumes/hr, and the resin in each interconnected chamber pair (A+B and C+D) takes m/n hrs to become spent. Thus, if the resin in each interconnected chamber pair is totally spent after treating or softening 100S bed volumes of water, and the feed water flow rate is 10S bed volumes/hr/interconnected chamber pair, the resin in each interconnected chamber pair takes 10 hrs to become spent.

Also, assume for example that the spent resin in each interconnected chamber pair (e.g., A+B and C+D) takes x*S bed volumes of regenerant to regenerate the resin (e.g., a total of 2x*S bed volumes for the entire column), and that the regenerant flow rate is y*S bed volume/hr, the resin in each interconnected chamber pair (A+B and C+D) is regenerated in x/y hrs. Thus, if the resin in each interconnected chamber pair is regenerated with 5S bed volumes of water, and the regenerant flow rate is 1S bed volumes/hr/interconnected chamber pair, the resin in each interconnected chamber pair takes 5 hrs to become regenerated.

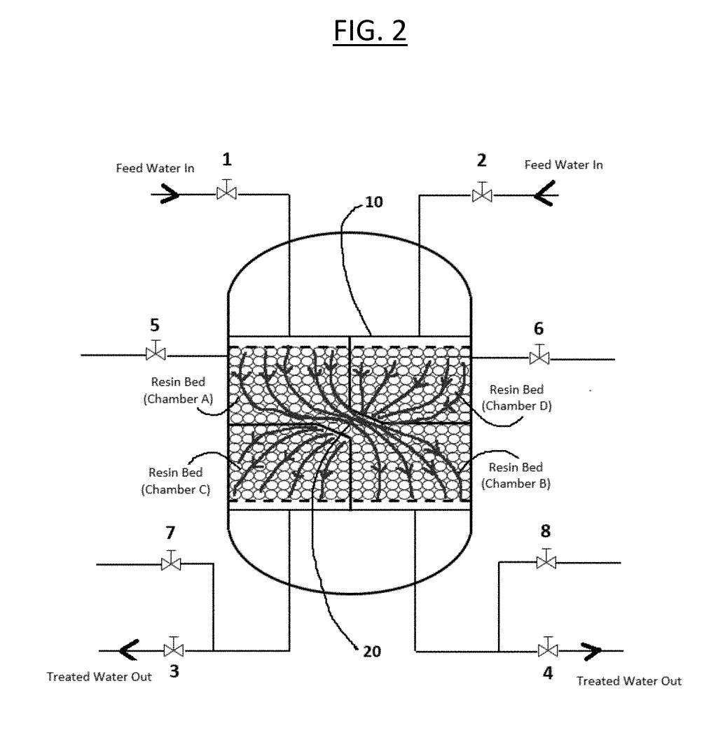

In a first or initial step, at time t=0, feed water inlet valve 1 and treated water outlet valve 4 (FIG. 1A) are open. All other valves (i.e., valves 2, 3, 5, 6, 7 and 8) are closed. Feed water at a flow rate of m*S bed volume/hr enters into interconnected chamber pair A+B through feedwater inlet valve 1 and passes through a tortuous path (depicted in FIG. 2) and treated or softened water exits from treated water outlet valve 4.

This process continues for (m/n)−(x/y) hrs (which is the time for the resin in one interconnected chamber pair to become spent, minus the time to regenerate the resin in an interconnected chamber pair). In our example, m=100S, n=10S/hr, x=5S and y=1S/hr, so the first or initial step treats or softens 50S bed volumes of water during 5 hrs of operation. Only the chamber pair A+B is in operation for water treatment/softening during the first or initial step, and the chamber pair C+D is standby mode.

In a second step, the feed water inlet valve 2 and treated water outlet valve 3 are opened. Now, feed water at a flow rate of n*S bed volumes/hr starts to pass through the interconnected chamber pair C+D as the feed water continues to pass through the interconnected chamber pair A+B at the same flow rate. The total water treatment/softening rate during this second step is n*S+n*S=2n*S bed volumes/hr. Both interconnected pairs (A+B and C+D) continue to treat/soften water until the resin in pair A+B is fully spent. Thus, 2n*(x/y)S bed volumes of water are treated/softened during this second step. In our example, n=10S/hr, x=5S and y=1S/hr, so 100S bed volumes of water are treated or softened during the 5 hrs of operation in the second step. Both chamber pairs A+B and C+D are in operation mode for water treatment/softening.

In a third step, the resin in chamber pair A+B is regenerated. Feed water inlet valve 1 and treated/softened water outlet valve 4 are closed. Water treatment/softening continues in chamber pair C+D at a flow rate of n*S bed volumes/hr.

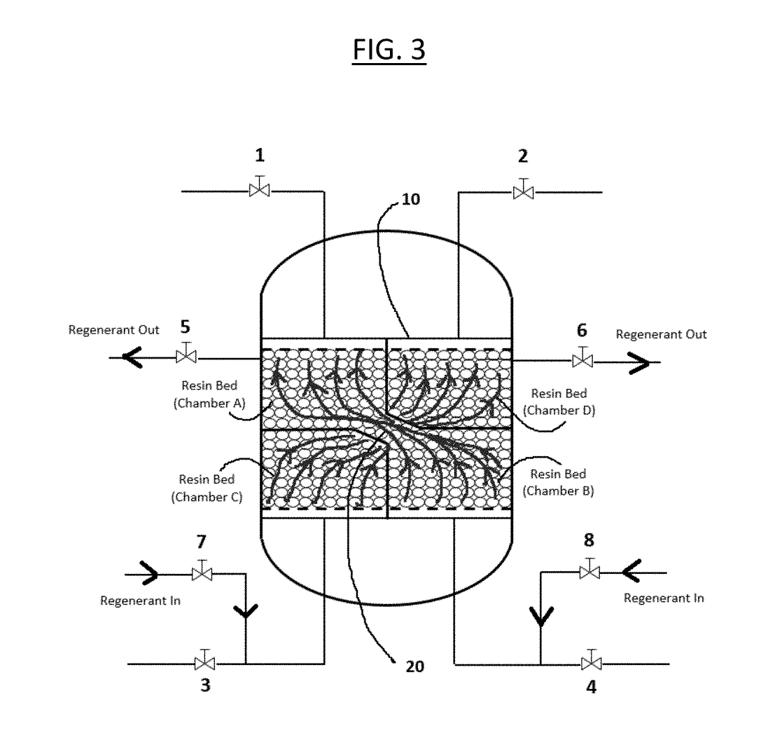

Now, feed water inlet valve 8 and treated water outlet valve 5 are opened. Regenerant starts to enter into chamber pair A+B from the bottom (valve 8) at a rate of y*S bed volumes/hr and exits through valve 5 after passing through a regenerant tortuous path (depicted in FIG. 3). Regeneration of resin in the chamber pair A+B takes x/y hrs, during which n*(x/y)*S bed volumes of water are treated/softened. In our example, 50S bed volumes of water are treated or softened during the 5 hrs of operation. Chamber pair C+D is in operation mode for water treatment/softening, and chamber pair A+B is in regeneration mode during the third step.

In a fourth step, after the regeneration cycle for A+B is completed, the resin in chamber pair C+D is regenerated. Regenerant inlet valve 7 and regenerant outlet valve 6 are opened, and regenerant enters into chamber pair C+D from the bottom (valve 7) at a rate of y*S bed volumes/hr and exits through valve 6 after passing through the regenerant tortuous path depicted in FIG. 3. Regeneration of the resin in chamber pair C+D takes x/y hrs. In our example, 50S bed volumes of water are treated/softened during 5 hrs of operation in the fourth step. Chamber pair A+B is in operation mode for water treatment/softening, and chamber pair C+D is in regeneration mode.

When m/n>2x/y, the method may optionally close regenerant inlet valve 8 and regenerant outlet valve 5 and open feed water inlet valve 1 and treated water outlet valve 4 between the third and fourth steps so that both interconnected pairs of chambers continue to treat/soften water until the resin in pair C+D is fully spent. The total water treatment rate is n*S+n*S=2n*S bed volumes/hr in this optional step, as both chamber pairs A+B and C+D are in operation mode for water treatment/softening.

In a fifth step, after the regeneration cycle for chamber pair C+D is completed, the regenerant inlet valve 7 and the regenerant outlet valve 6 are closed, and the feed water inlet valve 2 and the treated water outlet valve 3 are opened. Both interconnected chamber pairs A+B and C+D treat or soften feed water until the resin in the chamber pair A+B is fully spent. The total water treatment rate is n*S+n*S=2n*S bed volumes/hr. In our example, 100S bed volumes of water are treated/softened during 5 hrs of operation. Both chamber pairs A+B and C+D are in operation mode for water treatment/softening. After the fifth step, the resin in chamber pair A+B is spent and is to be regenerated in the next step. Thus, the fifth step of the method is essentially the same as the second step of the method.

In one embodiment, the second through fourth steps are repeated. The repetition continues until the treatment/softening process is interrupted for some reason (e.g., scheduled maintenance, etc.). Assuming that repetition of the second through fourth steps happens after an initial 5 hrs of operation, in each successive 15 hrs of continuous operation, 200S bed volumes of water may be treated/softened with alternative regeneration of resin in the chamber pairs A+B and C+D.

In summary, in our example, the fourth step includes chambers A+B in treatment/softening mode, and chambers C+D in regeneration mode. The step takes 5 hrs, and 50S bed volumes of water are treated.

The third step includes chamber pair C+D in treatment/softening mode, and chamber pair A+B in regeneration mode. In our example, the step takes 5 hrs, and 50S bed volumes of water are treated.

The second step includes both chambers A+B and C+D in treatment/softening mode. In our example, the step takes 5 hrs, and 100S bed volumes of water are treated.

There is no regeneration “standby” mode in the disclosed method. Therefore, more of the tank, column or bed is used for demineralization activities. In addition, compared to the Becucci patent, more feed water is demineralized in the same tank, column or bed during the same time period using the disclosed method.

The physical demineralization and regeneration compartment set-up within the tank, column or bed is different from that disclosed by Becucci. The present invention moves the regenerant in a tortuous path (see FIG. 3), resulting in increased residence time (explained more fully below).

If we compare the present design with that of Becucci under identical conditions (e.g., an ion exchange column with two chambers having a total bed volume of 2S [i.e., 1S bed volume per chamber], a water treatment/softening rate of n*S bed volumes/hr/chamber, and a regeneration cycle using x*S bed volumes of regenerant per chamber at a regenerant flow rate of y*S bed volume/hr), then under the recited conditions and using our example (i.e., n=10S/hr, x=5S and y=1S/hr), the system of Becucci is believed to treat or soften a total of 200S bed volumes of water and regenerate the spent resin in half of the chambers during each 20 hrs of continuous operation. By comparison, for each 15 hrs of continuous operation, the present column and method treat or soften 200S bed volumes of water and regenerate the spent resin in all of the chambers, greatly increasing the efficiency of the continuous ion exchange process.

As can be seen from FIG. 1A, the present design may include fewer valves that the design disclosed by Becucci, and the present column or bed may have external dimensions that are identical to the column in Becucci. Also, the movement of feed water during treatment/softening cycles (as depicted in FIG. 2) and of regenerant during regeneration cycles (as depicted in FIG. 3) along relatively long and tortuous paths results in an increased residence time, thus making both treatment/softening and regeneration processes more efficient. An increased residence time helps to reduce the regeneration cycle time and to increase the feed water flow rate during the treatment/softening cycle.

If the present column or bed is compared with a conventional one-chamber ion exchange column or bed under identical conditions (e.g., an ion exchange column with a total of 2S bed volume, a water treatment/softening rate of 2n*S bed volumes/hr, and a regeneration cycle that uses 2x*S bed volumes of regenerant at a regenerant flow rate of 2y*S bed volumes/hr), then for each cycle of continuous operation, the conventional design is believed to treat a total of (T−(2x/2y)])*2n*S bed volumes of water, where T is the length of the continuous cycle, and regeneration occurs only when all of the resin is spent in treatment/softening cycle. By contrast, in the present invention, for each cycle of continuous operation, (T−[2(x/y)/2])*2n*S bed volumes of water, with alternative regeneration of the resin in the interconnected chamber pairs A+B and C+D. Looking at our example, under identical conditions, for each 15 hrs of continuous operation, the conventional one-chamber ion exchange column or bed treats or softens 200S bed volumes of water, but cannot treat or soften feed water during the regeneration cycle. In comparison, for each 15 hrs of continuous operation, the present invention continuously treats or softens 200S bed volumes of water and regenerates the spent resin in all of the chambers. In addition, the present column design results in a longer residence time between the resin on the one hand and the feed water or regenerant on the other hand, resulting in reduced regeneration cycle time, increased feed water flow rate during the treatment/softening cycle, and increased efficiency in both the treatment/softening process and the regeneration process.

The present column or bed may have external dimensions that are identical to the conventional one-column design, although internal partitioning may sacrifice some of the space in the column or bed. However, a reduction in resin bed volume does not affect the overall column capacity, as flow rates (e.g., feed water and regenerant) can be adjusted (e.g., slightly increased) in the present design to compensate for any internal reduction of resin bed volume due to placement or partitioning of the interconnected chamber pairs (A+B, C+D).

### CONCLUSION/SUMMARY

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed, and that modifications and other embodiments are intended to be included within the scope of the appended claims. Although specific terms are employed herein, they are used in a generic and descriptive sense only, and not for purposes of limitation.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. An ion exchange bed or column, comprising:
a) a first plurality of interconnected chambers supporting a first portion of an ion exchange resin;
b) a second plurality of interconnected chambers supporting a second portion of the ion exchange resin, the second plurality of interconnected chambers being physically isolated and/or separated from the first plurality of interconnected chambers; and
c) a housing or casing enclosing the first and second plurality of interconnected chambers and the first and second portions of the ion exchange resin,
wherein the ion exchange bed or column is configured to cause a fluid passing through (i) the first plurality of interconnected chambers to travel along a path that is longer than a height of the first plurality of interconnected chambers, and (ii) the second plurality of interconnected chambers to travel along a path that is longer than a height of the second plurality of interconnected chambers.

2. The ion exchange bed or column of claim 1, wherein the first plurality of interconnected chambers comprises a first chamber, a second chamber, and a conduit connecting the first chamber to the second chamber.

3. The ion exchange bed or column of claim 2, wherein the second plurality of interconnected chambers comprises a third chamber, a fourth chamber, and one or more openings connecting the third chamber to the fourth chamber.

4. The ion exchange bed or column of claim 3, further comprising a first partition separating the first chamber from the fourth chamber, a second partition separating the first chamber from the third chamber, a third partition separating the second chamber from the fourth chamber, and a fourth partition separating the second chamber from the third chamber.

5. The ion exchange bed or column of claim 1, further comprising a first fluid inlet valve at an inlet of the first plurality of interconnected chambers, a first treated fluid outlet valve at a first outlet of the first plurality of interconnected chambers, a second fluid inlet valve at an inlet of the second plurality of interconnected chambers, and a second treated fluid outlet valve at a first of the second plurality of interconnected chambers.

6. The ion exchange bed or column of claim 5, further comprising a first regenerant inlet valve at the first outlet of the first plurality of interconnected chambers, a first regenerant outlet valve at a second outlet of the first plurality of interconnected chambers, a second regenerant inlet valve at the first outlet of the second plurality of interconnected chambers, and a second regenerant outlet valve at a second outlet of the second plurality of interconnected chambers.

7. exchange bed or column of claim 1, adapted for water hardness treatment and/or boron removal.

8. The ion exchange bed or column of claim 1, adapted to regenerate spent resin in one of the first and second pluralities of interconnected chambers while continuously feeding the fluid for ion exchange in the other of the first and second pluralities of interconnected chambers.

9. A method of exchanging ions in a fluid, comprising:
a) for a first period of time, passing the fluid through (i) a first portion of an ion exchange resin in a first plurality of interconnected chambers and (ii) a second portion of the ion exchange resin in a second plurality of interconnected chambers, the second plurality of interconnected chambers being physically isolated and/or separated from the first plurality of interconnected chambers;
b) after the first period of time, regenerating the first portion of the ion exchange resin in the first plurality of interconnected chambers while continuing to pass the fluid through the second portion of the ion exchange resin in the second plurality of interconnected chambers; and
c) after the first portion of the ion exchange resin in the first plurality of interconnected chambers is regenerated, regenerating the second portion of the ion exchange resin in the second plurality of interconnected chambers and passing the fluid through the first portion of the ion exchange resin in the first plurality of interconnected chambers,
wherein the ion exchange bed or column is configured to cause the fluid passing through the first plurality of interconnected chambers to travel along a path that is longer than a height of the first plurality of interconnected chambers, and the fluid passing through the second plurality of interconnected chambers to travel along a path that is longer than a height of the second plurality of interconnected chambers.

10. The method of claim 9, wherein the fluid comprises water.

11. The method of claim 9, further comprising continuously repeating the method.

12. The method of claim 9, wherein the further comprising, prior to the first period of time, passing the fluid through the first portion of the ion exchange resin in the first plurality of interconnected chambers for an initial period of time.

13. The method of claim 9, wherein regenerating each of the first and second portions of the ion exchange resin comprises passing a regenerant through the corresponding or respective portion of the ion exchange resin.

14. The method of claim 13, wherein each of the first and second portions of the ion exchange resin has a unit volume of S, the fluid is passed through each of the first and second pluralities of interconnected chambers at a flow rate of n*S unit volumes/hr, the ion exchange resin in each of the first and second pluralities of interconnected chambers is regenerated after passing m*S unit volumes of fluid through the corresponding or respective plurality of interconnected chambers, each of the first and second portions of the ion exchange resin is regenerated with x*S unit volumes of regenerant, and the regenerant is passed through the corresponding or respective first and second portions of the ion exchange resin at a flow rate of y*S unit volumes/hr.

15. The method of claim 14, wherein when (m/n)>2(x/y), the method further comprises passing the fluid through (i) the first portion of the ion exchange resin in the first plurality of interconnected chambers and (ii) the second portion of the ion exchange resin in the second plurality of interconnected chambers for a second period of time, after regenerating the first portion of the ion exchange resin and prior to regenerating the second portion of the ion exchange resin.

16. The method of claim 9, wherein the first plurality of interconnected chambers comprises a first chamber, a second chamber, and a conduit connecting the first chamber to the second chamber.

17. The method of claim 16, wherein the second plurality of interconnected chambers comprises a third chamber, a fourth chamber, and one or more openings connecting the third chamber to the fourth chamber.

18. The method of claim 17, further comprising a first partition separating the first chamber from the fourth chamber, a second partition separating the first chamber from the third chamber, a third partition separating the second chamber from the fourth chamber, and a fourth partition separating the second chamber from the third chamber.
